(19) United States
(12) Patent Application Publication
(10) Pub. No.: US 2025/0247891 A1
(43) Pub. Date: Jul. 31, 2025

(54) FOUR-STEP RACH PROCEDURE FOR ENERGY HARVESTING USER EQUIPMENT

(71) Applicant: QUALCOMM Incorporated, San Diego, CA (US)

(72) Inventors: Linhai HE, San Diego, CA (US); Wanshi CHEN, San Diego, CA (US); Jing LEI, San Diego, CA (US); Ahmed ELSHAFIE, San Diego, CA (US); Seyedkianoush HOSSEINI, San Diego, CA (US); Huilin XU, Temecula, CA (US); Yuchul KIM, San Diego, CA (US); Zhikun WU, Beijing (CN); Peter GAAL, San Diego, CA (US)

(21) Appl. No.: 18/854,667

(22) PCT Filed: May 17, 2022
(86) PCT No.: PCT/CN2022/093232

§ 371 Date: Oct. 7, 2024

(51) Int. Cl. H04W 74/0833; H02J 50/00; H02J 50/80

(52) U.S. Cl. CPC H04W 74/0833; H02J 50/001; H02J 50/80

(57) ABSTRACT

Various aspects of the present disclosure generally relate to wireless communication. In some aspects, a network node may configure a set of energy harvesting classes associated with performing a four-step random access channel (RACH) procedure. The network node may perform the four-step RACH procedure based at least in part on an energy harvesting class of the set of energy harvesting classes. Numerous other aspects are described.

### FIELD OF THE DISCLOSURE

Aspects of the present disclosure generally relate to wireless communication and to techniques and apparatuses for a four-step random access channel (RACH) procedure for energy harvesting user equipment (UEs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include configuring a set of energy harvesting classes associated with performing a four-step random access channel (RACH) procedure. The method may include performing the four-step RACH procedure based at least in part on an energy harvesting class of the set of energy harvesting classes.

Some aspects described herein relate to a method of wireless communication performed by a user equipment (UE). The method may include receiving a first indication of a set of energy harvesting classes associated with a network node. The method may include transmitting a second indication of an energy harvesting class, of the set of energy harvesting classes, to the network node. The method may include performing a four-step RACH procedure based at least in part on the energy harvesting class.

Some aspects described herein relate to a network node for wireless communication. The network node may include a memory and one or more processors coupled to the memory. The one or more processors may be configured to configure a set of energy harvesting classes associated with performing a four-step RACH procedure. The one or more processors may be configured to perform the four-step RACH procedure based at least in part on an energy harvesting class of the set of energy harvesting classes.

Some aspects described herein relate to a UE for wireless communication. The UE may include a memory and one or more processors coupled to the memory. The one or more processors may be configured to receive a first indication of a set of energy harvesting classes associated with a network node. The one or more processors may be configured to transmit a second indication of an energy harvesting class, of the set of energy harvesting classes, to the network node. The one or more processors may be configured to perform a four-step RACH procedure based at least in part on the energy harvesting class.

Some aspects described herein relate to a non-transitory computer-readable medium that stores a set of instructions for wireless communication by a network node. The set of instructions, when executed by one or more processors of the network node, may cause the network node to configure a set of energy harvesting classes associated with performing a four-step RACH procedure. The set of instructions, when executed by one or more processors of the network node, may cause the network node to perform the four-step RACH procedure based at least in part on an energy harvesting class of the set of energy harvesting classes.

Some aspects described herein relate to a non-transitory computer-readable medium that stores a set of instructions for wireless communication by a UE. The set of instructions, when executed by one or more processors of the UE, may cause the UE to receive a first indication of a set of energy harvesting classes associated with a network node. The set of instructions, when executed by one or more processors of the UE, may cause the UE to transmit a second indication of an energy harvesting class, of the set of energy harvesting classes, to the network node. The set of instructions, when executed by one or more processors of the UE, may cause the UE to perform a four-step RACH procedure based at least in part on the energy harvesting class.

Some aspects described herein relate to an apparatus for wireless communication. The apparatus may include means for configuring a set of energy harvesting classes associated with performing a four-step RACH procedure. The apparatus may include means for performing the four-step RACH procedure based at least in part on an energy harvesting class of the set of energy harvesting classes.

Some aspects described herein relate to an apparatus for wireless communication. The apparatus may include means for receiving a first indication of a set of energy harvesting classes associated with a network node. The apparatus may include means for transmitting a second indication of an energy harvesting class, of the set of energy harvesting classes, to the network node. The apparatus may include means for performing a four-step RACH procedure based at least in part on the energy harvesting class.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a four-step random access channel (RACH) procedure, in accordance with the present disclosure.

FIG. 5 is a diagram illustrating an example associated with a four-step RACH procedure for energy harvesting UEs, in accordance with the present disclosure.

FIGS. 6 and 7 are diagrams illustrating example processes associated with a four-step RACH procedure for energy harvesting UEs, in accordance with the present disclosure.

FIGS. 8 and 9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

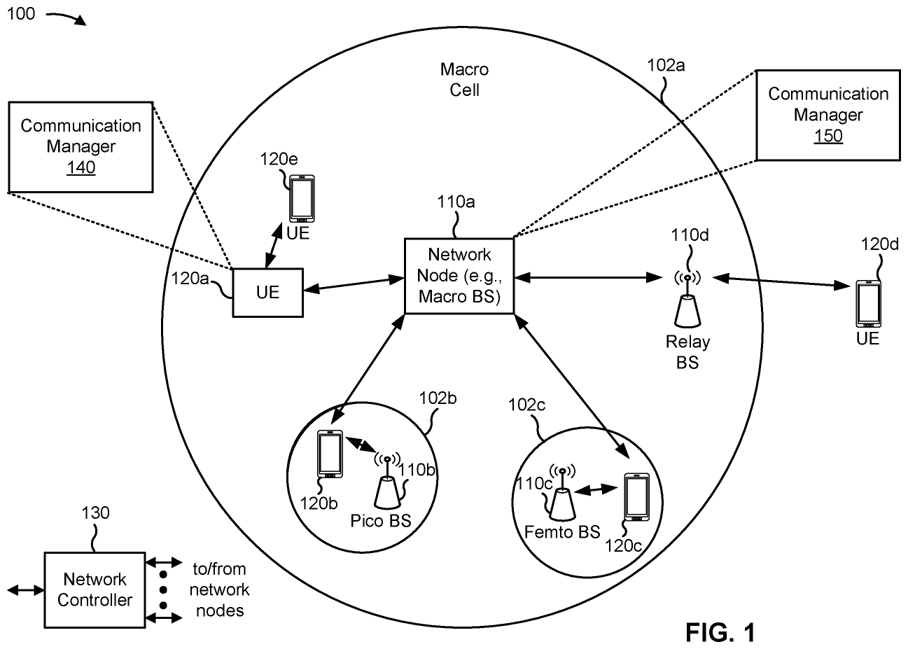

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A network node 110 is an entity that communicates with UEs 120. A network node 110 (sometimes referred to as a BS) may include, for example, an NR base station, an LTE base station, a Node B, an eNB (e.g., in 4G), a gNB (e.g., in 5G), an access point, and/or a transmission reception point (TRP). Each network node 110 may provide communication coverage for a particular geographic area. In the Third Generation Partnership Project (3GPP), the term “cell” can refer to a coverage area of a network node 110 and/or a subsystem of the network node 110 serving this coverage area, depending on the context in which the term is used.

A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro base station. A network node 110 for a pico cell may be referred to as a pico base station. A network node 110 for a femto cell may be referred to as a femto base station or an in-home base station. In the example shown in FIG. 1, the network node 110a may be a macro base station for a macro cell 102a, the network node 110b may be a pico base station for a pico cell 102b, and the network node 110c may be a femto base station for a femto cell 102c. A network node 110 may support one or multiple (e.g., three) cells.

In some examples, a cell may not necessarily be stationary, and the geographic area of the cell may move according to the location of a network node 110 that is mobile (e.g., a mobile base station). In some examples, the network nodes 110 may be interconnected to one another and/or to one or more other network nodes 110 (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a network node 110 or a UE 120) and send a transmission of the data to a downstream station (e.g., a UE 120 or a network node 110). A relay station may be a UE 120 that can relay transmissions for other UEs 120. In the example shown in FIG. 1, the network node 110d (e.g., a relay base station) may communicate with the network node 110a (e.g., a macro base station) and the UE 120d in order to facilitate communication between the network node 110a and the UE 120d. A network node 110 that relays communications may be referred to as a relay station, a relay base station, a relay, or the like.

The wireless network 100 may be a heterogeneous network that includes network nodes 110 of different types, such as macro base stations, pico base stations, femto base stations, relay base stations, or the like. These different types of network nodes 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may configure a set of energy harvesting classes associated with performing a four-step random access channel (RACH) procedure; and perform the four-step RACH procedure based at least in part on an energy harvesting class of the set of energy harvesting classes. Additionally, or alternatively, the communication manager 150 may perform one or more other operations described herein.

In some aspects, the UE 120 may include a communication manager 140. As described in more detail elsewhere herein, the communication manager 140 may receive a first indication of a set of energy harvesting classes associated with a network node; transmit a second indication of an energy harvesting class, of the set of energy harvesting classes, to the network node; and perform a four-step RACH procedure based at least in part on the energy harvesting class. Additionally, or alternatively, the communication manager 140 may perform one or more other operations described herein.

As described herein, a node, which may be referred to as a “node,” a “network node,” or a “wireless node,” may be a base station (e.g., network node 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

As indicated above, FIG. 1 is provided as an example. Other examples may differ from what is described with regard to FIG. 1.

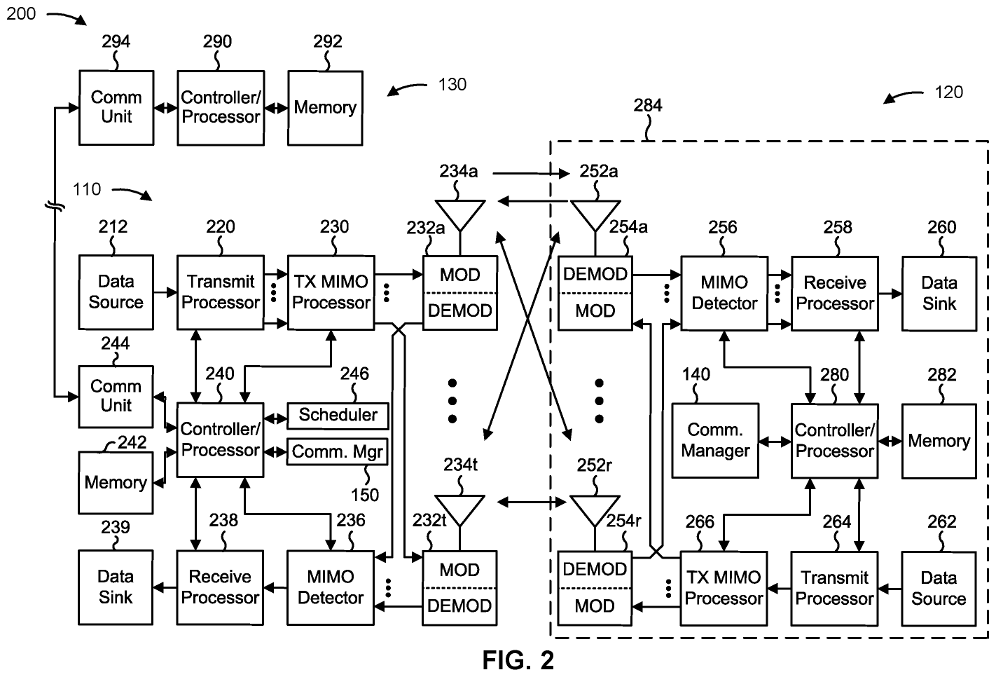

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1).

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

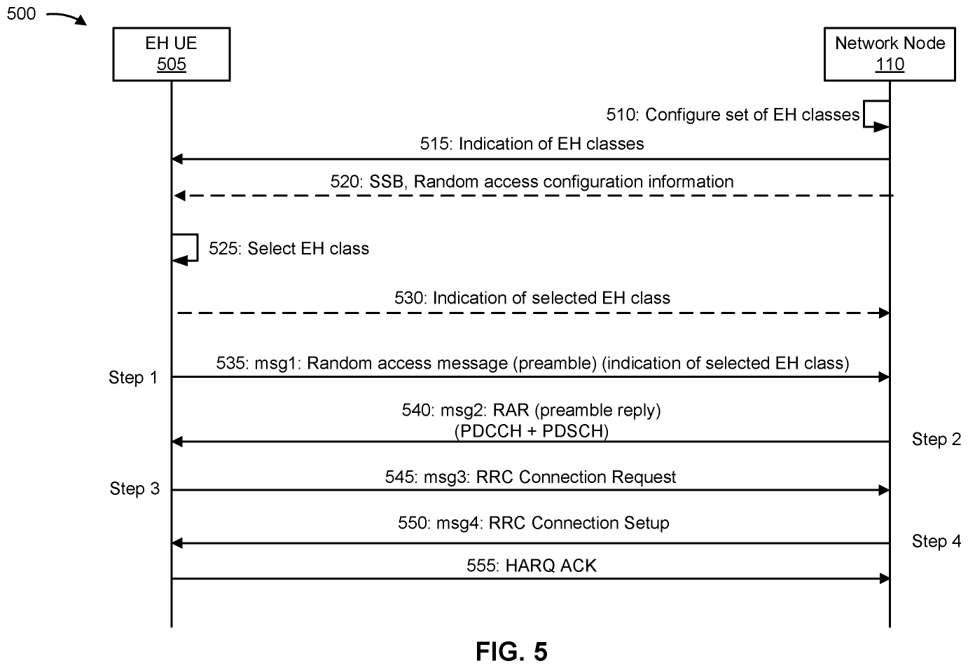

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

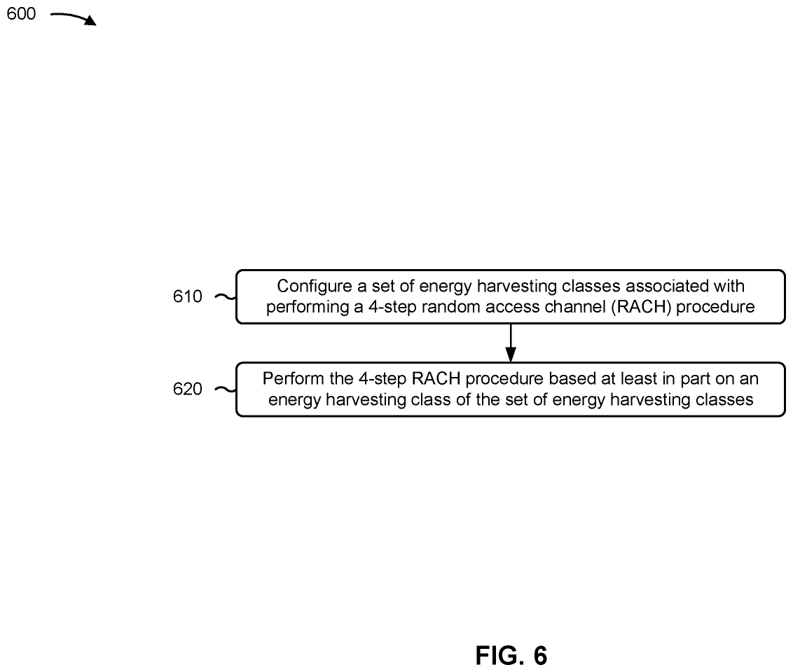

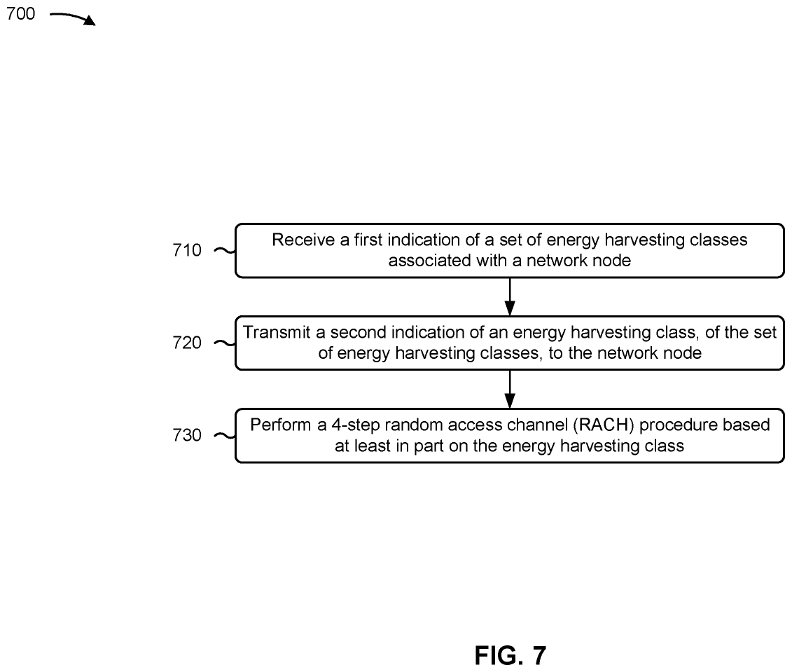

The controller/processor 240 of the network node 110, the controller/processor 280 of the UE 120, and/or any other component(s) of FIG. 2 may perform one or more techniques associated with a four-step RACH procedure for energy harvesting UEs, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the network node 110 includes means for configuring a set of energy harvesting classes associated with performing a four-step RACH procedure; and/or means for performing the four-step RACH procedure based at least in part on an energy harvesting class of the set of energy harvesting classes. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE 120 includes means for receiving a first indication of a set of energy harvesting classes associated with a network node; means for transmitting a second indication of an energy harvesting class, of the set of energy harvesting classes, to the network node; and/or means for performing a four-step RACH procedure based at least in part on the energy harvesting class. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, the term “network node” (e.g., the network node 110) may refer to an aggregated base station, a disaggregated base station, and/or one or more components of a disaggregated base station. For example, in some aspects, “network node” may refer to a control unit, a distributed unit, a plurality of control units, a plurality of distributed units, and/or a combination thereof. In some aspects, “network node” may refer to one device configured to perform one or more functions such as those described above in connection with the network node 110. In some aspects, “network node” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “network node” may refer to any one or more of those different devices. In some aspects, “network node” may refer to one or more virtual network nodes, one or more virtual network node functions, and/or a combination of thereof. For example, in some cases, two or more network node functions may be instantiated on a single device. In some aspects, “network node” may refer to one of the network node functions and not another. In this way, a single device may include more than one network node.

As indicated above, FIG. 2 is provided as an example. Other examples may differ from what is described with regard to FIG. 2.

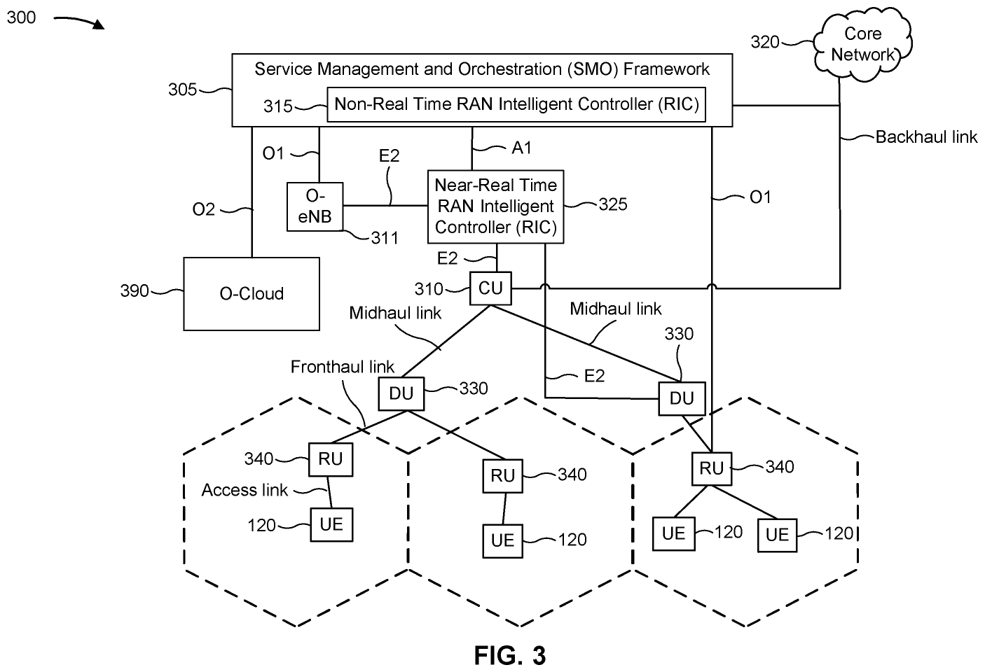

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., network node 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual centralized unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some aspects, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some aspects, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some aspects, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some aspects, the SMO Framework 305 can communicate with a hardware aspect of a 4G RAN, such as an open eNB (O-eNB) 311, via an O1 interface. Additionally, in some aspects, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some aspects, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

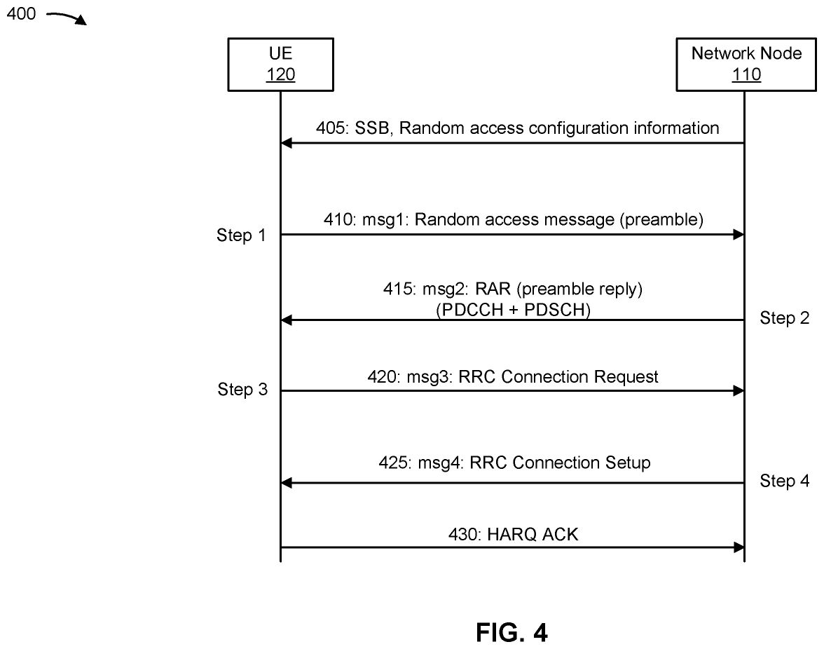

FIG. 4 is a diagram illustrating an example 400 of a four-step random access procedure, in accordance with the present disclosure. As shown in FIG. 4, a network node 110 and a UE 120 may communicate with one another to perform the four-step random access procedure.

As shown by reference number 405, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The RAM may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC packet data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) ACK.

As indicated above, FIG. 4 is provided as an example. Other examples may differ from what is described with regard to FIG. 4.

An energy harvesting (EH) powered device can opportunistically harvest energy in the environment, such as solar, heat, and/or ambient RF radiation, and store the energy in a rechargeable battery. An amount of energy that can be harvested by an EH powered device, and/or a rate at which the EH powered device is able to harvest energy, may be dependent upon current environmental conditions. For example, an EH powered device that is configured to harvest solar energy may be able to harvest more energy, and/or harvest the energy at a faster rate, on a sunny day rather than on a cloudy day or at night. Thus, an amount of energy available to the EH powered device for transmitting and/or receiving data may vary based at least in part on current environmental conditions.

Because the amount of energy available to the EH powered device for transmitting and/or receiving data may vary based at least in part on current environmental conditions, the EH powered device may not have a sufficient amount of energy to perform an entire four-step RACH procedure in a single active duration (e.g., without having to harvest additional energy before completing the four-step RACH procedure.

Some techniques and apparatuses described herein enable a network node (e.g., a network node 110) to configure a plurality of EH classes for performing a four-step RACH procedure. Each EH class may be associated with UEs having different EH capabilities. For example, each EH class may be configured with different RACH resources and/or RACH parameters that are determined based at least in part on a maximum duty cycle that can be supported by a UE. The plurality of EH classes may enable each UE to select a particular EH class for performing a four-step RACH procedure based at least in part on an amount of energy currently available to the UE and/or based at least in part on a rate at which the UE is able to harvest energy. In some aspects, a UE may select the same EH class, or a different EH class, to perform a RACH retransmission and/or a new four-step RACH procedure.

As a result, a UE may reduce a likelihood of the UE being unable to complete the four-step RACH procedure as a result of an insufficient amount of available energy. Reducing the likelihood of the UE being unable to complete the four-step RACH procedure may reduce a quantity of failed RACH attempts, thereby conserving resources that otherwise would have been utilized to perform a RACH retransmission and/or a new four-step RACH procedure.

FIG. 5 is a diagram illustrating an example 500 associated with a four-step RACH procedure for EH UEs, in accordance with the present disclosure. As shown in FIG. 5, example 500 includes communication between a network node 110 and an EH UE 505 (e.g., a UE 120 with an EH capability). In some aspects, the network node 110 and the EH UE 505 may be included in a wireless network, such as wireless network 100. The network node 110 and the UE 505 may communicate via a wireless access link, which may include an uplink and a downlink.

As shown in FIG. 5, and by reference number 510, the network node 110 may configure a set of EH classes. In some aspects, an EH class, of the set of EH classes, may be configured for a UE having a particular EH capability. For example, an EH class may be configured for a maximum duty cycle that a UE is able to support, a UE having a particular amount of available energy at a start of a four-step RACH procedure, and/or a UE being able to harvest energy at a particular rate.

In some aspects, the network node 110 may configure a set of RACH parameters and/or a set of RACH resources for each EH class. In some aspects, the RACH parameters and the RACH resources configured for each EH class may be different from the RACH parameters and the RACH resources configured for other EH classes. As described in greater detail below, in some aspects, the set of RACH parameters configured for each EH class may include access criteria associated with selecting the EH class, a PRACH preamble set, a set of PRACH occasions, a quantity of slots after a transmission of a first message of the four-step RACH procedure that a UE is to begin monitoring for a transmission of a second message of the four-step RACH procedure, a quantity of RAR windows, an amount of time between two consecutive RAR windows, a quantity of retransmissions of the first message, a quantity of slots between repetitions of a transmission of a third message of the four-step RACH procedure, a total quantity of repetitions of the third message that may be transmitted by a UE, and/or a time period associated with a contention resolution timer, among other examples.

As shown by reference number 515, the network node 110 may transmit, and the EH UE 505 may receive, an indication of the configured set of EH classes. In some aspects, the network node 110 may advertise in system information the set of EH classes supported by the network node 110, the RACH parameters associated with each EH class, and/or the RACH resources configured with each EH class.

In some aspects, as shown by reference number 520, the network node 110 may transmit RACH configuration information to the EH UE 505. In some aspects, the network node 110 may transmit the RACH configuration information in a manner similar to that described above with respect to FIG. 4. In some aspects, the RACH configuration information may include the indication of the set of EH classes.

As shown by reference number 525, the EH UE 505 may select an EH class, from the configured set of EH classes, for performing the four-step RACH procedure. In some aspects, the EH UE 505 may select the EH class based at least in part on an amount of energy currently available to the EH UE 505 and/or a rate at which the EH UE 505 is able to harvest energy.

In some aspects, the EH UE 505 may select the EH class based at least in part on access criteria associated with each EH class. In some aspects, the access criteria of an EH class may be configured to ensure that the EH UE 505 has a sufficient amount of energy (with and/or without the EH UE 505 having to harvest energy during the four-step RACH procedure) to complete at least one RACH attempt.

In some aspects, the access criteria for an EH class may be associated with an amount of energy the EH UE 505 is to have at a start of the four-step RACH procedure. For example, for a particular EH class (Eₖ), the network node 110 may configure a value (Xₖ) that indicates a percentage (e.g., 25%, 50%, 75%, or 90%, among other examples) of a minimum amount of energy (Eₘᵢₙ) required by the EH UE 505 to complete one RACH attempt.

In some aspects, because the minimum amount of energy (Eₘᵢₙ) may be different for different UEs, the network node 110 may indicate the value (Xₖ) (e.g., the network node 110 may not indicate the minimum amount of energy (Eₘᵢₙ)). A particular UE (e.g., the EH UE 505) may determine the amount of energy that the UE is to have at the start of the four-step RACH procedure based at least in part on the value (Xₖ) and the minimum amount of energy (Eₘᵢₙ) required for that particular UE to complete one RACH attempt.

In some aspects, the access criteria for an EH class may be associated with a rate at which a UE is able to harvest energy. For example, the network node 110 may advertise a minimum rate (EHₖ) at which a UE is to harvest energy for an energy class (Eₖ). In some aspects, the minimum rate (EHₖ) may be expressed as a percentage (ƒₖ %) such that ƒₖ % multiplied by a UE's minimum amount of energy (Eₘᵢₙ) equals a minimum amount of energy the UE is to be able to harvest during an amount of time corresponding to one transmission slot.

In some aspects, as shown by reference number 530, the EH UE 505 may transmit an indication of the selected EH class prior to transmitting a first message of the four-step RACH procedure. For example, the EH UE 505 may transmit a message indicating the selected EH class after (or prior to) performing an RSRP measurement on a downlink reference signal.

In some aspects, as shown by reference number 535, the EH UE 505 may transmit a first message of the four-step RACH procedure that includes an indication of the selected EH class. In some aspects, the EH UE 505 may transmit the first message of the four-step RACH procedure in a manner similar to that described above with respect to FIG. 4.

In some aspects, the EH UE 505 may delay transmitting the first message for a time period after performing the RSRP measurement on the downlink reference signal. In some aspects, the time period may be determined based at least in part on a rate at which the EH UE 505 harvests energy. For example, the time period may correspond to an amount of time for the EH UE 505 to harvest enough energy to transmit the first message and/or to monitor for a transmission of a second message of the four-step RACH procedure.

As shown by reference number 540, the network node 110 may transmit a second message of the four-step RACH procedure to the EH UE 505. In some aspects, the network node 110 may transmit the second message in a manner similar to that described above with respect to FIG. 4.

In some aspects, the network node 110 may configure an amount of time (T₁). Amount of time (T₁) may correspond to a quantity of slots after an end of the first message of the four-step RACH procedure before the EH UE 505 is to monitor for the transmission of the second message.

In some aspects, the amount of time (T₁) may correspond to an amount of time required for a UE to harvest an amount of energy to receive the second message during at least one RAR window (described in greater detail below). For example, the network node 110 may configure an amount of time (T₁) for each EH class based at least in part on a rate at which a UE, for which the EH class is targeted, harvests energy.

In some aspects, the network node 110 may transmit a plurality of second messages. Each second message may be transmitted during a respective RAR window. An RAR window may correspond to a time period during which a UE is to monitor for a transmission of the second message.

In some aspects, the network node 110 configures a quantity of RAR windows (N₁) and a duration (T₂) between two consecutive RAR windows for the set of EH classes (e.g., the same quantity of RAR windows (N1) and the same duration (T₂) is configured for each EH class). In some aspects, the network node 110 configures a respective quantity of RAR windows (N₁) and a respective duration (T₂) between two consecutive RAR windows for each EH class.

In some aspects, the EH UE 505 may identify a quantity of RAR windows (N₁) and a duration (T₂) between two consecutive RAR windows configured for the selected EH class. The EH UE 505 may select an RAR window of the quantity of RAR windows (N₁) to monitor for the transmission of the second message. In some aspects, the EH UE 505 may select the RAR window based at least in part on an amount of energy available to the EH UE 505 to monitor for the transmission of the second message, a rate at which the EH UE 505 harvests energy, and/or an amount of time required for the EH UE 505 to harvest an amount of energy for the EH UE 505 to have enough energy available to monitor for the transmission of the second message.

The EH UE 505 may monitor for a transmission of the second message during the selected RAR window. In some aspects, the EH UE 505 may not receive the second message during the selected RAR window and/or may receive a second message having a preamble identifier that does not match the preamble identifier included in the first message. In some aspects, the EH UE 505 may monitor another RAR window based at least in part on not receiving the second message during the selected RAR window and/or based at least in part on receiving a second message having a preamble identifier that does not match the preamble identifier included in the first message.

In some aspects, the EH UE 505 may determine that the RACH attempt is unsuccessful based at least in part on not receiving the second message during the selected RAR window (and/or during the other RAR window) and/or based at least in part on receiving a second message having a preamble identifier that does not match the preamble identifier included in the first message. The EH UE 505 may terminate a process associated with receiving the second message and may perform a retransmission of the first message based at least in part on the RACH attempt being unsuccessful.

In some aspects, the EH UE 505 may retransmit the first message of the four-step RACH procedure to the network node 110 and may monitor for a transmission of the second message in a manner similar to that described above. In some aspects, the EH UE 505 may increase a number of preamble transmissions counter and/or a transmission power for the retransmission of the first message based at least in part on the EH UE 505 not receiving the second message during the selected RAR window.

In some aspects, the EH UE 505 may select another EH class, from the plurality of EH classes configured by the network node 110, based at least in part on retransmitting the first message. In some aspects, the retransmitted first message may include an indication of the other EH class selected by the EH UE 505.

In some aspects, the EH UE 505 may retransmit the first message to the network node 110 after harvesting an amount of energy. For example, the EH UE 505 may retransmit the first message after harvesting an amount of energy for satisfying an access criterion associated with the selected EH class or the other EH class selected by the EH UE 505, an amount of energy for retransmitting the first message, and/or an amount of energy for retransmitting the first message and monitoring for the second message, among other examples.

In some aspects, the EH UE 505 may not have enough energy to monitor for a transmission of a second message during the entire RAR window (e.g., the EH UE 505 runs out of energy while monitoring for the second message) and/or to monitor for a transmission of the second message during any of the RAR windows configured by the network node 110. The EH UE 505 may perform a retransmission of the first message based at least in part on the EH UE 505 not having enough energy to monitor for a transmission of a second message during the entire RAR window (e.g., the EH UE 505 runs out of energy while monitoring for the second message) and/or to monitor for a transmission of the second message during any of the RAR windows configured by the network node 110.

In some aspects, the EH UE 505 may not be able to determine whether the network node 110 received the initial transmission of the first message based at least in part on the EH UE 505 having insufficient energy to monitor for the second message. Because the EH UE 505 may not be able to determine whether the network node 110 received the initial transmission of the first message, the EH UE 505 may not increase the number of preamble transmissions counter and/or the transmit power for the retransmission of the first message. Alternatively, the EH UE 505 may increase the number of preamble transmissions counter and/or the transmit power for the retransmission of the first message in a manner similar to that described above.

In some aspects, the EH UE 505 may receive a second message during the selected RAR window. The EH UE 505 may determine that a preamble identifier included in the second message matches the preamble identifier included in the first message. The EH UE 505 may determine that the reception of the second message is successful based at least in part on receiving the second message having the preamble identifier that matches the preamble identifier included in the first message.

As shown by reference number 545, the EH UE 505 may transmit a third message of the four-step RACH procedure to the network node 110 based at least in part on the reception of the second message being successful. In some aspects, the EH UE 505 may transmit the third message in a manner similar to that described above with respect to FIG. 4.

In some aspects, the EH UE 505 may transmit the third message via a set of resources indicated in the second message. For example, the second message may comprise an uplink grant or may indicate a PUSCH resource for transmission of the third message. In some aspects, the network node 110 transmits a plurality of second messages (e.g., one second message during each RAR window) and one or more second messages, of the plurality of second messages, may indicate a PUSCH resource that is different from a PUSCH resource indicated by one or more other second messages.

In some aspects, the EH UE 505 transmits an indication of an earliest slot in which the EH UE 505 is able to receive a fourth message of the four-step RACH procedure. In some aspects, the indication of the earliest slot is transmitted via a media access control-control element (MAC-CE). In some aspects, a logical channel priority associated with the MAC-CE may be a highest logical channel priority relative to other MAC-CEs. Additionally, or alternatively, the indication of the earliest slot may be included in the third message.

In some aspects, the EH UE 505 may transmit an indication of an earliest slot in which the network node 110 is to transmit a retransmission of the fourth message. In some aspects, the indication of the earliest slot in which the network node 110 is to transmit a retransmission of the fourth message is included in the third message.

In some aspects, the third message may include an indication (e.g., a bit set to a particular value) of a request for an expedited process of the four-step RACH procedure. The expedited process may enable the EH UE 505 to have a sufficient amount of energy available to complete the four-step RACH procedure. For example, the expedited process may include the network node 110 transmitting the fourth message with a higher transmit power and/or a lower MCS to reduce an amount of time associated with the EH UE 505 receiving the fourth message and/or to enable the EH UE 505 to have a sufficient amount of energy to complete the four-step RACH procedure.

In some aspects, the EH UE 505 may have an insufficient amount of energy to transmit the third message via a set of resources indicated in the second message. The EH UE 505 may determine that the transmission of the third message is unsuccessful based at least in part on having an insufficient amount of energy to transmit the third message via the set of resources indicated in the second message. The EH UE 505 may retransmit the first message based at least in part on the transmission of the third message being unsuccessful.

In some aspects, the EH UE 505 may select another EH class based at least in part on retransmitting the first message. In some aspects, the EH UE 505 may select the other EH class and/or may transmit an indication of the other EH class in a manner similar to that described above.

In some aspects, the EH UE 505 may not increase the number of preamble transmissions counter and/or the transmission power for the retransmission of the first message. The EH UE 505 may not increase the number of preamble transmissions counter and/or the transmission power for the retransmission of the first message based at least in part on the EH UE 505 having an insufficient amount of energy to transmit the third message via the set of resources (e.g., rather than the second message not being successfully received by the network node 110).

In some aspects, the EH UE 505 may retransmit the first message to the network node 110 based at least in part on failing to transmit the third message prior to an expiration of a timer configured by the network node 110. For example, the network node 110 may configure a timer for a timing alignment indication provided in the second message. The EH UE 505 may determine that the transmission of the third message is unsuccessful and/or may retransmit the first message to the network node 110, based at least in part on failing to transmit the third message prior to the expiration of the timer.

In some aspects, the EH UE 505 may begin monitoring for a transmission of the fourth message at the earliest slot indicated in the third message. In some aspects, the EH UE 505 may initiate a contention resolution timer based at least in part on the EH UE 505 starting to monitor for the transmission of the fourth message. The EH UE 505 may consider that the reception of the fourth message is unsuccessful and/or may retransmit the first message to the network node 110 when the fourth message is not received by the EH UE 505 prior to the expiration of the contention resolution timer.

In some aspects, the network node 110 may configure the transmission of the third message with repetition. For example, for each EH class, the network node 110 may configure a quantity of slots between two consecutive repetitions of the third message and/or a total quantity of repetitions of the third message.

In some aspects, the EH UE 505 may determine which repetitions to transmit and/or which repetitions to skip based at least in part on an amount of energy available to the EH UE 505 and/or a rate at which the EH UE 505 is able to harvest energy. In some aspects, the EH UE 505 may restart the contention resolution timer after transmitting each repetition of the third message. In some aspects, the EH UE 505 may skip a transmission of a repetition based at least in part on the EH UE 505 having an insufficient amount of energy. The EH UE 505 may stop the contention resolution timer based at least in part on the EH UE 505 skipping the transmission of the repetition as a result of the EH UE 505 having an insufficient amount of energy.

As shown by reference number 550, the network node 110 may transmit a fourth message of the four-step RACH procedure to the EH UE 505. In some aspects, the network node 110 may transmit the fourth message in a manner similar to that described above with respect to FIG. 4.

In some aspects, the EH UE 505 may receive the fourth message prior to the expiration of the contention resolution timer. The EH UE 505 may determine that the fourth message includes an identifier associated with the EH UE 505 and/or an uplink grant addressed to a radio network temporary identifier (RNTI) associated with the EH UE 505. The EH UE 505 may determine that the reception of the fourth message is successful and/or that the four-step RACH procedure is successfully completed based at least in part on receiving a fourth message that includes the identifier associated with the EH UE 505 and/or the uplink grant address to the RNTI associated with the EH UE 505 prior to the expiration of the contention resolution timer. As shown by reference number 555, the EH UE 505 may transmit a HARQ acknowledgement to the network node 110 based at least in part on the reception of the fourth message being successful and/or based at least in part on the four-step RACH procedure being successful completed.

As described above, by configuring a plurality of EH classes that are targeted to UEs having various EH capabilities, the network node 110 may enable each UE to select an EH class for performing a four-step RACH procedure based at least in part on an amount of available energy and/or a rate at which each UE is available to harvest energy. In this way, a likelihood of a UE being unable to complete a four-step RACH procedure as a result of an insufficient amount of available energy may be reduced. Reducing the likelihood of a UE being unable to complete the four-step RACH procedure may reduce a quantity of failed RACH attempts, thereby conserving resources that otherwise would have been utilized to perform a RACH retransmission and/or a new four-step RACH procedure.

As indicated above, FIG. 5 is provided as an example. Other examples may differ from what is described with respect to FIG. 5.

FIG. 6 is a diagram illustrating an example process 600 performed, for example, by a network node, in accordance with the present disclosure. Example process 600 is an example where the network node (e.g., network node 110) performs operations associated with four-step RACH procedure for EH UEs.

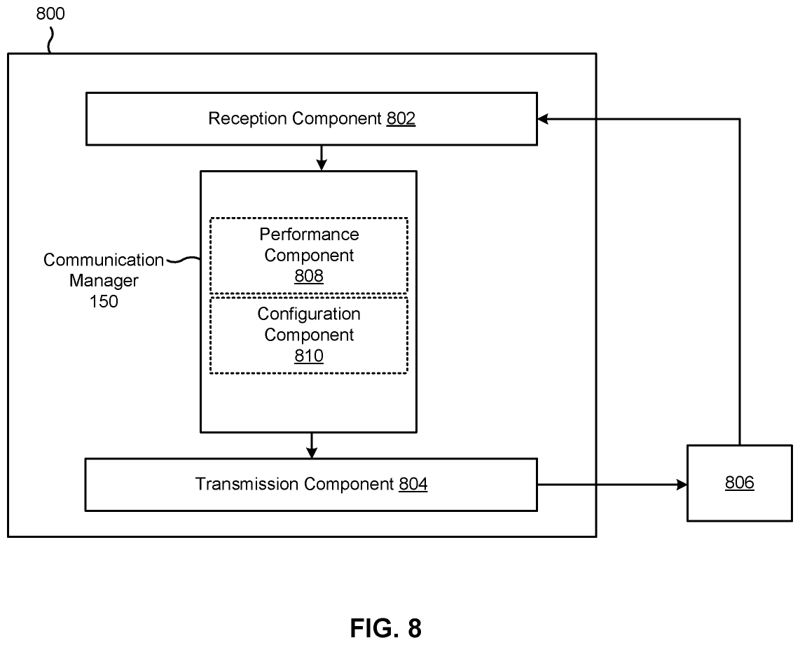

As shown in FIG. 6, in some aspects, process 600 may include configuring a set of energy harvesting classes associated with performing a four-step RACH procedure (block 610). For example, the network node (e.g., using communication manager 150 and/or configuration component 810, depicted in FIG. 8) may configure a set of energy harvesting classes associated with performing a four-step RACH procedure, as described above.

As further shown in FIG. 6, in some aspects, process 600 may include performing the four-step RACH procedure based at least in part on an energy harvesting class of the set of energy harvesting classes (block 620). For example, the network node (e.g., using communication manager 150 and/or performance component 808, depicted in FIG. 8) may perform the four-step RACH procedure based at least in part on an energy harvesting class of the set of energy harvesting classes, as described above.

Process 600 may include additional aspects, such as any single aspect or any combination of aspects described below and/or in connection with one or more other processes described elsewhere herein.

In a first aspect, process 600 includes providing an indication of the set of energy harvesting classes, and receiving an indication of the energy harvesting class, wherein the four-step RACH procedure is performed based at least in part on the energy harvesting class based at least in part on receiving the indication of the energy harvesting class.

In a second aspect, alone or in combination with the first aspect, providing the indication of the set of energy harvesting classes comprises advertising the set of energy harvesting classes in system information.

In a third aspect, alone or in combination with one or more of the first and second aspects, the system information includes an indication of a set of RACH parameters associated with each energy harvesting class, of the set of energy harvesting classes.

In a fourth aspect, alone or in combination with one or more of the first through third aspects, the set of RACH parameters associated with each EH class includes one or more of a PRACH preamble set or a set of PRACH occasions.

In a fifth aspect, alone or in combination with one or more of the first through fourth aspects, the EH class is configured based at least in part on a first EH capability associated with a first group of UEs, and another EH class, of the set of EH classes, is configured based at least in part on a second EH capability associated with a second group of UEs.

In a sixth aspect, alone or in combination with one or more of the first through fifth aspects, the first EH capability includes a first maximum duty cycle that a first UE included in the first group of UEs can support during the four-step RACH procedure, and the second EH capability includes a second maximum duty cycle that a second UE included in the second group of UEs can support during the four-step RACH procedure.

In a seventh aspect, alone or in combination with one or more of the first through sixth aspects, each EH class, of the set of energy harvesting classes, is configured with different RACH resources.

In an eighth aspect, alone or in combination with one or more of the first through seventh aspects, each EH class, of the set of EH classes, is configured with different RACH parameters.

In a ninth aspect, alone or in combination with one or more of the first through eighth aspects, process 600 includes advertising access criteria associated with each EH class, of the set of EH classes.

In a tenth aspect, alone or in combination with one or more of the first through ninth aspects, the access criteria include one or more of an amount of energy that a UE is to have prior to performing the four-step RACH procedure, or a rate at which the UE harvests energy.

In an eleventh aspect, alone or in combination with one or more of the first through tenth aspects, the amount of energy that the UE is to have prior to performing the four-step RACH procedure corresponds to a percentage of an amount of energy required for the UE to complete at least one RACH attempt.

In a twelfth aspect, alone or in combination with one or more of the first through eleventh aspects, the access criteria indicate the percentage of the amount of energy required for the UE to complete at least one RACH attempt.

In a thirteenth aspect, alone or in combination with one or more of the first through twelfth aspects, the EH class is configured with a quantity of slots after an end of a first message transmission of the four-step RACH procedure before a UE is to monitor for a transmission of a second message of the four-step RACH procedure.

In a fourteenth aspect, alone or in combination with one or more of the first through thirteenth aspects, the quantity of slots corresponds to an amount of time associated with the UE harvesting at least an amount of energy associated with the UE monitoring for the transmission of the second message during a time period.

In a fifteenth aspect, alone or in combination with one or more of the first through fourteenth aspects, for each EH class, of the set of EH classes, the network node configures a quantity of time periods during which the second message is transmitted, and a duration between two consecutive time periods, of the quantity of time periods.

In a sixteenth aspect, alone or in combination with one or more of the first through fifteenth aspects, process 600 includes transmitting, during a first time period of the quantity of time periods, a first uplink grant indicating a first PUSCH for a transmission of a third message of the four-step RACH procedure, and transmitting, during a second time period of the quantity of time periods, a second uplink grant indicating a second PUSCH for the transmission of the third message.

In a seventeenth aspect, alone or in combination with one or more of the first through sixteenth aspects, the first PUSCH is different from the second PUSCH.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with the present disclosure. Example process 700 is an example where the UE (e.g., UE 505) performs operations associated with four-step RACH procedure for EH UEs.

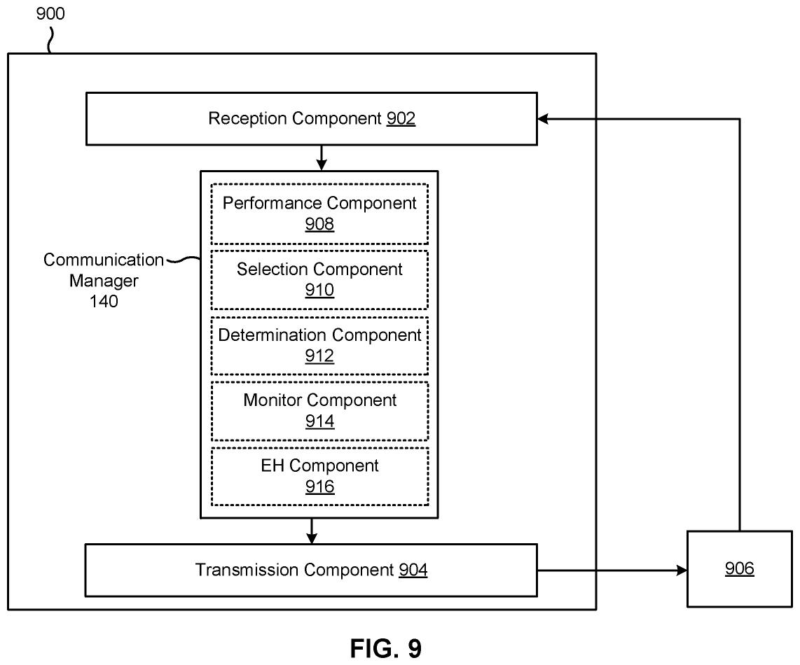

As shown in FIG. 7, in some aspects, process 700 may include receiving a first indication of a set of EH classes associated with a network node (block 710). For example, the UE (e.g., using communication manager 140 and/or reception component 902, depicted in FIG. 9) may receive a first indication of a set of EH classes associated with a network node, as described above.

As further shown in FIG. 7, in some aspects, process 700 may include transmitting a second indication of an EH class, of the set of EH classes, to the network node (block 720). For example, the UE (e.g., using communication manager 140 and/or transmission component 904, depicted in FIG. 9) may transmit a second indication of an EH class, of the set of EH classes, to the network node, as described above.

As further shown in FIG. 7, in some aspects, process 700 may include performing a four-step RACH procedure based at least in part on the EH class (block 730). For example, the UE (e.g., using communication manager 140 and/or performance component 908, depicted in FIG. 9) may perform a four-step RACH procedure based at least in part on the EH class, as described above.

Process 700 may include additional aspects, such as any single aspect or any combination of aspects described below and/or in connection with one or more other processes described elsewhere herein.

In a first aspect, process 700 includes selecting the EH class, from the set of EH classes, based at least in part on one or more of an amount of available energy or an EH rate.

In a second aspect, alone or in combination with the first aspect, process 700 includes transmitting an indication of another EH class, of the set of EH classes, and performing a RACH retransmission or another four-step RACH procedure based at least in part on the other EH class.

In a third aspect, alone or in combination with one or more of the first and second aspects, the other EH class is different from the EH class.

In a fourth aspect, alone or in combination with one or more of the first through third aspects, process 700 includes receiving access criteria for each EH class, of the set of EH classes, determining that an energy level associated with the UE satisfies the access criteria for the EH class, and selecting the EH class, from the set of EH classes, based at least in part on the energy level associated with the UE satisfying the access criteria for the EH class.

In a fifth aspect, alone or in combination with one or more of the first through fourth aspects, process 700 includes performing a measurement on a downlink signal, and transmitting a first message of the four-step RACH procedure based at least in part on performing the measurement, wherein the first message is transmitted a quantity of slots after performing the measurement on the downlink signal, and wherein the UE harvests an amount of energy for transmitting the first message during a time period corresponding to the quantity of slots.

In a sixth aspect, alone or in combination with one or more of the first through fifth aspects, process 700 includes receiving a configuration indicating a quantity of slots, and monitoring for a second message of the four-step RACH procedure during a time period, wherein a start of the time period occurs the quantity of slots after a transmission of a first message of the four-step RACH procedure.

In a seventh aspect, alone or in combination with one or more of the first through sixth aspects, process 700 includes harvesting an amount of energy for receiving the second message during a time period corresponding to the quantity of slots.

In an eighth aspect, alone or in combination with one or more of the first through seventh aspects, process 700 includes receiving a configuration indicating a quantity of time periods for monitoring for a second message of the four-step RACH procedure and a duration between two consecutive time periods of the quantity of time periods, and monitoring for the second message during a time period, of the quantity of time periods, wherein the time period is selected based at least in part on an energy level of the UE.

In a ninth aspect, alone or in combination with one or more of the first through eighth aspects, process 700 includes determining that the second message is not received during the time period, and retransmitting a first message of the four-step RACH procedure based at least in part on the second message not being received during the time period.

In a tenth aspect, alone or in combination with one or more of the first through ninth aspects, process 700 includes selecting another EH class from the set of EH classes, and transmitting an indication of the other EH class, wherein the indication is transmitted prior to retransmitting the first message.

In an eleventh aspect, alone or in combination with one or more of the first through tenth aspects, process 700 includes receiving the second message during the time period, and transmitting an indication of an earliest slot in which the UE is able to receive a fourth message of the four-step RACH procedure.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a network node, or a network node may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150. The communication manager 150 may include one or more of a performance component 808 or a configuration component 810, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the network node described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the network node described in connection with FIG. 2. In some aspects, the transmission component 804 may be co-located with the reception component 802 in a transceiver.

The configuration component 810 may configure a set of energy harvesting classes associated with performing a four-step RACH procedure. The performance component 808 may perform the four-step RACH procedure based at least in part on an EH class of the set of EH classes.

The transmission component 804 may provide an indication of the set of EH classes.

The reception component 802 may receive an indication of the energy harvesting class, wherein the four-step RACH procedure is performed based at least in part on the EH class based at least in part on receiving the indication of the EH class.

The transmission component 804 may transmit, during a first time period of the quantity of time periods, a first uplink grant indicating a first PUSCH for a transmission of a third message of the four-step RACH procedure.

The transmission component 804 may transmit, during a second time period of the quantity of time periods, a second uplink grant indicating a second PUSCH for the transmission of the third message.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a performance component 908, a selection component 910, a determination component 912, a monitor component 914, or an EH component 916, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive a first indication of a set of EH classes associated with a network node. The transmission component 904 may transmit a second indication of an EH class, of the set of EH classes, to the network node. The performance component 908 may perform a four-step RACH procedure based at least in part on the EH class.

The selection component 910 may select the EH class, from the set of EH classes, based at least in part on one or more of an amount of available energy or an EH rate.

The transmission component 904 may transmit an indication of another EH class, of the set of EH classes.

The performance component 908 may perform a RACH retransmission or another four-step RACH procedure based at least in part on the other EH class.

The reception component 902 may receive access criteria for each EH class, of the set of EH classes.

The determination component 912 may determine that an energy level associated with the UE satisfies the access criteria for the EH class.

The selection component 910 may select the EH class, from the set of EH classes, based at least in part on the energy level associated with the UE satisfying the access criteria for the EH class.

The performance component 908 may perform a measurement on a downlink signal.

The transmission component 904 may transmit a first message of the four-step RACH procedure based at least in part on performing the measurement. The first message may be transmitted a quantity of slots after performing the measurement on the downlink signal, and the UE may harvest an amount of energy for transmitting the first message during a time period corresponding to the quantity of slots.

The reception component 902 may receive a configuration indicating a quantity of slots.

The monitor component 914 may monitor for a second message of the four-step RACH procedure during a time period, wherein a start of the time period occurs the quantity of slots after a transmission of a first message of the four-step RACH procedure.

The EH component 916 may harvest an amount of energy for receiving the second message during a time period corresponding to the quantity of slots.

The reception component 902 may receive a configuration indicating a quantity of time periods for monitoring for a second message of the four-step RACH procedure and a duration between two consecutive time periods of the quantity of time periods.

The monitor component 914 may monitor for the second message during a time period, of the quantity of time periods, wherein the time period is selected based at least in part on an energy level of the UE.

The determination component 912 may determine that the second message is not received during the time period.

The transmission component 904 may retransmit a first message of the four-step RACH procedure based at least in part on the second message not being received during the time period.

The selection component 910 may select another EH class from the set of EH classes.

The transmission component 904 may transmit an indication of the other EH class, wherein the indication is transmitted prior to retransmitting the first message.

The reception component 902 may receive the second message during the time period.

The transmission component 904 may transmit an indication of an earliest slot in which the UE is able to receive a fourth message of the four-step RACH procedure.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a network node, comprising: configuring a set of EH classes associated with performing a four-step RACH procedure; and performing the four-step RACH procedure based at least in part on an EH class of the set of EH classes.
Aspect 2: The method of Aspect 1, further comprising: providing an indication of the set of EH classes; and receiving an indication of the EH class, wherein the four-step RACH procedure is performed based at least in part on the EH class based at least in part on receiving the indication of the EH class.
Aspect 3: The method of Aspect 2, wherein providing the indication of the set of EH classes comprises: advertising the set of EH classes in system information.
Aspect 4: The method of Aspect 3, wherein the system information includes an indication of a set of RACH parameters associated with each EH class, of the set of EH classes.
Aspect 5: The method of Aspect 4, wherein the set of RACH parameters associated with each EH class includes one or more of a PRACH preamble set or a set of PRACH occasions.
Aspect 6: The method of one or more of Aspects 1 through 5, wherein the EH class is configured based at least in part on a first EH capability associated with a first group of UEs, and another EH class, of the set of EH classes, is configured based at least in part on a second EH capability associated with a second group of UEs.
Aspect 7: The method of Aspect 6, wherein the first EH capability includes a first maximum duty cycle that a first UE included in the first group of UEs can support during the four-step RACH procedure, and the second EH capability includes a second maximum duty cycle that a second UE included in the second group of UEs can support during the four-step RACH procedure.
Aspect 8: The method of one or more of Aspects 1 through 7, wherein each EH class, of the set of EH classes, is configured with different RACH resources.
Aspect 9: The method of one or more of Aspects 1 through 8, wherein each EH class, of the set of EH classes, is configured with different RACH parameters.
Aspect 10: The method of one or more of Aspects 1 through 9, further comprising: advertising access criteria associated with each EH class, of the set of EH classes.
Aspect 11: The method of Aspect 10, wherein the access criteria include one or more of an amount of energy that a UE is to have prior to performing the four-step RACH procedure, or a rate at which the UE harvests energy.
Aspect 12: The method of Aspect 11, wherein the amount of energy that the UE is to have prior to performing the four-step RACH procedure corresponds to a percentage of an amount of energy required for the UE to complete at least one RACH attempt.
Aspect 13: The method of Aspect 12, wherein the access criteria indicate the percentage of the amount of energy required for the UE to complete at least one RACH attempt.
Aspect 14: The method of one or more of Aspects 1 through 13, wherein the EH class is configured with a quantity of slots after an end of a first message transmission of the four-step RACH procedure before a UE is to monitor for a transmission of a second message of the four-step RACH procedure.
Aspect 15: The method of Aspect 14, wherein the quantity of slots corresponds to an amount of time associated with the UE harvesting at least an amount of energy associated with the UE monitoring for the transmission of the second message during a time period.
Aspect 16: The method of Aspect 15, wherein for each EH class, of the set of EH classes, the network node configures a quantity of time periods during which the second message is transmitted, and a duration between two consecutive time periods, of the quantity of time periods.
Aspect 17: The method of Aspect 16, further comprising: transmitting, during a first time period of the quantity of time periods, a first uplink grant indicating a first PUSCH for a transmission of a third message of the four-step RACH procedure; and transmitting, during a second time period of the quantity of time periods, a second uplink grant indicating a second PUSCH for the transmission of the third message.
Aspect 18: The method of Aspect 17, wherein the first PUSCH is different from the second PUSCH.
Aspect 19: A method of wireless communication performed by a UE, comprising: receiving a first indication of a set of EH classes associated with a network node; transmitting a second indication of an EH class, of the set of EH classes, to the network node; and performing a four-step RACH procedure based at least in part on the EH class.
Aspect 20: The method of Aspect 19, further comprising: selecting the EH class, from the set of EH classes, based at least in part on one or more of an amount of available energy or an EH rate.
Aspect 21: The method of Aspect 19, further comprising: transmitting an indication of another EH class, of the set of EH classes; and performing a RACH retransmission or another four-step RACH procedure based at least in part on the other EH class.
Aspect 22: The method of Aspect 21, wherein the other EH class is different from the EH class.
Aspect 23: The method of one or more of Aspects 19 through 22, further comprising: receiving access criteria for each EH class, of the set of EH classes; determining that an energy level associated with the UE satisfies the access criteria for the EH class; and selecting the EH class, from the set of EH classes, based at least in part on the energy level associated with the UE satisfying the access criteria for the EH class.
Aspect 24: The method of one or more of Aspects 19 through 23, further comprising: performing a measurement on a downlink signal; and transmitting a first message of the four-step RACH procedure based at least in part on performing the measurement, wherein the first message is transmitted a quantity of slots after performing the measurement on the downlink signal, and wherein the UE harvests an amount of energy for transmitting the first message during a time period corresponding to the quantity of slots.
Aspect 25: The method of one or more of Aspects 19 through 24, further comprising: receiving a configuration indicating a quantity of slots; and monitoring for a second message of the four-step RACH procedure during a time period, wherein a start of the time period occurs the quantity of slots after a transmission of a first message of the four-step RACH procedure.
Aspect 26: The method of Aspect 25, further comprising: harvesting an amount of energy for receiving the second message during a time period corresponding to the quantity of slots.
Aspect 27: The method of one or more of Aspects 19 through 26, further comprising: receiving a configuration indicating a quantity of time periods for monitoring for a second message of the four-step RACH procedure and a duration between two consecutive time periods of the quantity of time periods; and monitoring for the second message during a time period, of the quantity of time periods, wherein the time period is selected based at least in part on an energy level of the UE.
Aspect 28: The method of Aspect 27, further comprising: determining that the second message is not received during the time period; and retransmitting a first message of the four-step RACH procedure based at least in part on the second message not being received during the time period.
Aspect 29: The method of Aspect 28, further comprising: selecting another EH class from the set of EH classes; and transmitting an indication of the other EH class, wherein the indication is transmitted prior to retransmitting the first message.
Aspect 30: The method of Aspect 27, further comprising: receiving the second message during the time period; and transmitting an indication of an earliest slot in which the UE is able to receive a fourth message of the four-step RACH procedure.
Aspect 31: An apparatus for wireless communication at a device, comprising a processor; memory coupled with the processor; and instructions stored in the memory and executable by the processor to cause the apparatus to perform the method of one or more of Aspects 1 through 18.
Aspect 32: A device for wireless communication, comprising a memory and one or more processors coupled to the memory, the one or more processors configured to perform the method of one or more of Aspects 1 through 18.
Aspect 33: An apparatus for wireless communication, comprising at least one means for performing the method of one or more of Aspects 1 through 18.
Aspect 34: A non-transitory computer-readable medium storing code for wireless communication, the code comprising instructions executable by a processor to perform the method of one or more of Aspects 1 through 18.
Aspect 35: A non-transitory computer-readable medium storing a set of instructions for wireless communication, the set of instructions comprising one or more instructions that, when executed by one or more processors of a device, cause the device to perform the method of one or more of Aspects 1 through 18.
Aspect 36: An apparatus for wireless communication at a device, comprising a processor; memory coupled with the processor; and instructions stored in the memory and executable by the processor to cause the apparatus to perform the method of one or more of Aspects 19 through 30.
Aspect 37: A device for wireless communication, comprising a memory and one or more processors coupled to the memory, the one or more processors configured to perform the method of one or more of Aspects 19 through 30.
Aspect 38: An apparatus for wireless communication, comprising at least one means for performing the method of one or more of Aspects 19 through 30.
Aspect 39: A non-transitory computer-readable medium storing code for wireless communication, the code comprising instructions executable by a processor to perform the method of one or more of Aspects 19 through 30.
Aspect 40: A non-transitory computer-readable medium storing a set of instructions for wireless communication, the set of instructions comprising one or more instructions that, when executed by one or more processors of a device, cause the device to perform the method of one or more of Aspects 19 through 30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
a memory; and
one or more processors, coupled to the memory, configured to:
configure a set of energy harvesting classes associated with performing a four-step random access channel (RACH) procedure; and
perform the four-step RACH procedure based at least in part on an energy harvesting class of the set of energy harvesting classes.

2. The network node of claim 1, wherein the one or more processors are further configured to:
provide an indication of the set of energy harvesting classes; and
receive an indication of the energy harvesting class, wherein the four-step RACH procedure is performed based at least in part on the energy harvesting class based at least in part on receiving the indication of the energy harvesting class.

3. The network node of claim 2, wherein the one or more processors, to provide the indication of the set of energy harvesting classes, are configured to:
advertise the set of energy harvesting classes in system information.

4. The network node of claim 3, wherein the system information includes an indication of a set of RACH parameters associated with each energy harvesting class, of the set of energy harvesting classes.

5. The network node of claim 4, wherein the set of RACH parameters associated with each energy harvesting class includes one or more of a PRACH preamble set or a set of PRACH occasions.

6. The network node of claim 1, wherein the energy harvesting class is configured based at least in part on a first energy harvesting capability associated with a first group of user equipment (UEs), and another energy harvesting class, of the set of energy harvesting classes, is configured based at least in part on a second energy harvesting capability associated with a second group of UEs.

7. The network node of claim 6, wherein the first energy harvesting capability includes a first maximum duty cycle that a first UE included in the first group of UEs can support during the four-step RACH procedure, and the second energy harvesting capability includes a second maximum duty cycle that a second UE included in the second group of UEs can support during the four-step RACH procedure.

8. The network node of claim 1, wherein each energy harvesting class, of the set of energy harvesting classes, is configured with different RACH resources.

9. The network node of claim 1, wherein each energy harvesting class, of the set of energy harvesting classes, is configured with different RACH parameters.

10. The network node of claim 1, wherein the one or more processors are further configured to:
advertising access criteria associated with each energy harvesting class, of the set of energy harvesting classes.

11. The network node of claim 10, wherein the access criteria include one or more of an amount of energy that a user equipment (UE) is to have prior to performing the four-step RACH procedure, or a rate at which the UE harvests energy.

12. The network node of claim 11, wherein the amount of energy that the UE is to have prior to performing the four-step RACH procedure corresponds to a percentage of an amount of energy required for the UE to complete at least one RACH attempt.

13. The network node of claim 12, wherein the access criteria indicate the percentage of the amount of energy required for the UE to complete at least one RACH attempt.

14. The network node of claim 1, wherein the energy harvesting class is configured with a quantity of slots after an end of a first message transmission of the four-step RACH procedure before a user equipment (UE) is to monitor for a transmission of a second message of the four-step RACH procedure.

15. The network node of claim 14, wherein the quantity of slots corresponds to an amount of time associated with the UE harvesting at least an amount of energy associated with the UE monitoring for the transmission of the second message during a time period.

16. The network node of claim 15, wherein for each energy harvesting class, of the set of energy harvesting classes, the network node configures a quantity of time periods during which the second message is transmitted, and a duration between two consecutive time periods, of the quantity of time periods.

17. The network node of claim 16, wherein the one or more processors are further configured to:
transmit, during a first time period of the quantity of time periods, a first uplink grant indicating a first physical uplink shared channel (PUSCH) for a transmission of a third message of the four-step RACH procedure; and
transmit, during a second time period of the quantity of time periods, a second uplink grant indicating a second PUSCH for the transmission of the third message.

18. The network node of claim 17, wherein the first PUSCH is different from the second PUSCH.

19. A user equipment (UE) for wireless communication, comprising:
a memory; and
one or more processors, coupled to the memory, configured to:
receive a first indication of a set of energy harvesting classes associated with a network node;
transmit a second indication of an energy harvesting class, of the set of energy harvesting classes, to the network node; and
perform a four-step random access channel (RACH) procedure based at least in part on the energy harvesting class.

20. The UE of claim 19, wherein the one or more processors are further configured to:
select the energy harvesting class, from the set of energy harvesting classes, based at least in part on one or more of an amount of available energy or an energy harvesting rate.

21. The UE of claim 19, wherein the one or more processors are further configured to:
transmit an indication of another energy harvesting class, of the set of energy harvesting classes; and
perform a RACH retransmission or another four-step RACH procedure based at least in part on the other energy harvesting class.

22. The UE of claim 21, wherein the other energy harvesting class is different from the energy harvesting class.

23. The UE of claim 19, wherein the one or more processors are further configured to:
receive access criteria for each energy harvesting class, of the set of energy harvesting classes;
determine that an energy level associated with the UE satisfies the access criteria for the energy harvesting class; and
select the energy harvesting class, from the set of energy harvesting classes, based at least in part on the energy level associated with the UE satisfying the access criteria for the energy harvesting class.

24. The UE of claim 19, wherein the one or more processors are further configured to:
perform a measurement on a downlink signal; and
transmit a first message of the four-step RACH procedure based at least in part on performing the measurement, wherein the first message is transmitted a quantity of slots after performing the measurement on the downlink signal, and wherein the UE harvests an amount of energy for transmitting the first message during a time period corresponding to the quantity of slots.

25. The UE of claim 19, wherein the one or more processors are further configured to:
receive a configuration indicating a quantity of slots; and
monitor for a second message of the four-step RACH procedure during a time period, wherein a start of the time period occurs the quantity of slots after a transmission of a first message of the four-step RACH procedure.

26. The UE of claim 25, wherein the one or more processors are further configured to:
harvest an amount of energy for receiving the second message during a time period corresponding to the quantity of slots.

27. The UE of claim 19, wherein the one or more processors are further configured to:
receive a configuration indicating a quantity of time periods for monitoring for a second message of the four-step RACH procedure and a duration between two consecutive time periods of the quantity of time periods; and
monitor for the second message during a time period, of the quantity of time periods, wherein the time period is selected based at least in part on an energy level of the UE.

28. The UE of claim 27, wherein the one or more processors are further configured to:
determine that the second message is not received during the time period; and
retransmit a first message of the four-step RACH procedure based at least in part on the second message not being received during the time period.

29. The UE of claim 28, wherein the one or more processors are further configured to:
select another energy harvesting class from the set of energy harvesting classes; and
transmit an indication of the other energy harvesting class, wherein the indication is transmitted prior to retransmitting the first message.

30. The UE of claim 27, wherein the one or more processors are further configured to:
receive the second message during the time period; and
transmit an indication of an earliest slot in which the UE is able to receive a fourth message of the four-step RACH procedure.
